(19) United States
(12) Patent Application Publication
(10) Pub. No.: US 2016/0026390 A1
(43) Pub. Date: Jan. 28, 2016

(54) METHOD OF DELETING INFORMATION, COMPUTER PROGRAM PRODUCT AND COMPUTER SYSTEM

(71) Applicant: Fujitsu Technology Solutions Intellectual Property GmbH, München (DE)

(72) Inventor: Thorsten Höhnke, Königsbrunn (DE)

(21) Appl. No.: 14/421,489

(22) PCT Filed: Apr. 8, 2014
(86) PCT No.: PCT/EP2014/057047

§ 371 Date: Feb. 13, 2015

(30) Foreign Application Priority Data
Apr. 22, 2013 (DE) 10 2013 104 036.5

(51) Int. Cl. G06F 3/06; H04L 29/08

(52) U.S. Cl. CPC G06F 3/0604; H04L 67/1097; G06F 3/0631; G06F 3/0652; G06F 3/0659; G06F 3/0683

(57) ABSTRACT

A method of deleting information from a memory provided via a data network and having dynamic memory location allocation includes determining the size and name of files stored in the memory, creating files having a predetermined content and a size and a name corresponding to the determined sizes and names of the files stored in the memory, overwriting the stored files in the memory with the corresponding created files, writing at least one file of a predetermined content to the entire remaining available memory, and waiting for a period of time predetermined by a memory provider to back up the memory, upon completion of the steps of overwriting and writing.

### TECHNICAL FIELD

This disclosure relates to a method of deleting information from a memory provided via a data network and has dynamic memory location allocation, the use of such a method, a computer program product and a computer system.

### BACKGROUND

To safeguard their data, more and more users of computer systems access memory services which are connected to the user's computer system via the Internet. Such memory services are, e.g., cloud storage providers. In that case, it is typical that a user does not know where his/her files have been stored. Typically, the users' data is stored with a cloud storage service on servers distributed around the world. It is also possible that not all of a user's data are stored on one server, but rather at different locations on various servers. Therefore, it is not possible for the user to influence the stored data in a physical manner. This offers inter alia a security advantage over conventional backups as unauthorized third parties are also not able to access data carriers comprising the stored data in a targeted manner.

It could therefore be helpful to provide a method of deleting information from a memory provided via a data network and has dynamic memory location allocation. It could also be helpful to provide for the use of such a method and apparatus suitable for this purpose.

### SUMMARY

I provide a method of deleting information from a memory provided via a data network and having dynamic memory location allocation including determining the size and name of files stored in the memory, creating files having a predetermine content and a size and a name corresponding to the determined sizes and names of the files stored in the memory; creating files having a predetermined content and a size and a name corresponding to the determined sizes and names of the files stored in the memory; overwriting the stored files in the memory with the corresponding created files; writing at least one file of a predetermined content to the entire remaining available memory; and waiting for a period of time predetermined by a memory provider to back up the memory, upon completion of the steps of overwriting and writing.

I also provide a computer program product including executable program code, wherein the program code is configured to carry out the method of deleting information from a memory provided via a data network and having dynamic memory location allocation including determining the size and name of files stored in the memory, creating files having a predetermine content and a size and a name corresponding to the determined sizes and names of the files stored in the memory; creating files having a predetermined content and a size and a name corresponding to the determined sizes and names of the files stored in the memory; overwriting the stored files in the memory with the corresponding created files; writing at least one file of a predetermined content to the entire remaining available memory; and waiting for a period of time predetermined by a memory provider to back up the memory, upon completion of the steps of overwriting and writing, and upon execution of the computer program product by a data processing apparatus.

I further provide a computer system including at least one data network connection, wherein the computer system is configured to establish, via the data network connection, a connection to at least one memory provided via a data network and has dynamic memory location allocation, and the computer system is further configured to perform the method of deleting information from a memory provided via a data network and having dynamic memory location allocation including determining the size and name of files stored in the memory, creating files having a predetermine content and a size and a name corresponding to the determined sizes and names of the files stored in the memory; creating files having a predetermined content and a size and a name corresponding to the determined sizes and names of the files stored in the memory; overwriting the stored files in the memory with the corresponding created files; writing at least one file of a predetermined content to the entire remaining available memory; and waiting for a period of time predetermined by a memory provider to back up the memory, upon completion of the steps of overwriting and writing.

### BRIEF DESCRIPTION OF THE DRAWINGS

FIG. 1 shows a flow diagram of a method in accordance with one example.

FIG. 2 shows a computer system in accordance with one example.

### LIST OF REFERENCE NUMERALS

1, 2, 3, 4, 5 method steps
CS computer system
DA data network connection
CL memory

### DETAILED DESCRIPTION

Our method of deleting information from a memory provided via a data network and has dynamic memory location allocation, in particular a cloud storage memory is described. The method may comprise the steps of:
determining the size and name of files stored in the memory,
creating files having a predetermined content and a size and a name corresponding to the determined sizes and names of the files stored in the memory,
overwriting the stored files in the memory with the corresponding created files,
writing at least one file of a predetermined content to the entire remaining available memory, and
waiting for a period of time predetermined by a memory provider to backup the memory, upon completion of the steps of overwriting and writing.

When using memories having dynamic memory location allocation, a user does not know where and how the files are stored. If the user loads a filed into the memory, e.g., a cloud storage memory, then this file is stored at any location, e.g., a server of the cloud storage provider. The file is indicated to the user, e.g., via a user interface. This indication comprises merely a link or a reference to the memory location of the file. The actual memory location of the file is not indicated to the user. If the user loads further files into the cloud storage memory or into the memory area of a cloud storage memory available to him/her, then items of data are again stored on one or a plurality of servers of the memory provider. However, this is generally a different memory location from the memory location of the first data. Such a division of data is not indicated to the user. If a user deletes in his/her user interface the references to the data, then new memory space is provided. The references to the user's stored data are deleted. The actual data stored on the server re retained. Therefore, it is possible, e.g., for unauthorized third parties to restore this data from the hardware memory of the server. The data stored by the memory provider are copies at regular intervals to apply a backup of the data. A user also has no influence over the information relating to the memory location and the manner in which these items of saved data are stored.

One advantage of our method is that data can be deleted such that the data which the user has stored and which the memory service provider has stored on a server or memory drive are definitively deleted, or are overwritten so that it is not possible to reconstruct the data.

The files for writing to the remaining memory may be files whose content can be determined in a bitwise manner. In particular, these files are container-less files.

Frequently, files which belong to a specific file group, or have a specific file format, have predetermined memory contents. Such files are called container files. By virtue of the fact that container-less files are used, it is possible to determine each individual bit of this file and thus of the memory area which has been written to.

The predetermined contents of the files may contain a sequence of logical ones corresponding to the determined length of the files. One advantage is that logical ones are written completely to the memory area allocated to the file. As a result, any content-related information is overwritten.

Determining the name of the file in the step of determining may comprise determining the format of the files. Furthermore, in the step of creating, the name may comprise a format-specific file identifier corresponding to the determined name.

An advantage of this approach is that the format of a corresponding file is simulated by naming the file according to a specific format. If the file is to look, e.g., like a .pdf file, a file is created whose name ends with “.pdf.”

Advantageously, the stored files may comprise in the steps of determining, creating and overwriting, all of the stored files allocated to a user. An advantage of such an approach is that all of the files which can be allocated to a user are overwritten. As a result, any files and data information which are allocated to the user are lost. This has a security advantage for the user.

A computer program product is also described below and comprises executable program code, wherein the program code is configured to carry out an above-described method upon execution of the computer program product by a data processing apparatus.

A computer system is described below. The computer system comprises at least one data network connection, wherein the computer system is configured to establish, via the data network connection, a connection to at least one memory provided via a data network and has dynamic memory location allocation. The computer system is further configured to perform the above-described methods.

FIG. 2 illustrates an arrangement comprising a computer system CS and a memory CL having dynamic memory location allocation. The computer system CS comprises a data network connection DA. The computer system CS can establish a connection to a network via the data network connection DA. The memory CL is connected to the network in the same way as the computer system CS. As a result, it is possible for the computer system CS to establish a connection to the memory CL via the data network connection DA. A user of the computer system CS can thus store data in the memory CL via the network. In this case, the computer system CS is, e.g., a home PC, a company server, a mobile telephone or a tablet PC. Essentially, a computer system CS can be considered to be any system which can store data in a memory via a network connection. In the example, the memory CL is a cloud storage memory. The provider of the memory CL provides the user of the computer system CS with a certain amount of memory space. This memory space is indicated to the user of the computer system CS in general via a user interface. However, this user interface indicates to the user merely the amount of memory available to the user. In this case, it is not indicated where this memory is. The available memory is allocated to a real memory at a specific location only by the memory provider. If a user stores, e.g., two files in the memory available to him, it is indicated on the user interface that two files are stored in a memory and the available memory is indicated as being reduced corresponding to the size of the files. The files are not necessarily stored by the memory provider in one physical memory, but each file is stored in its own right on various physical memories. These memories are generally very much larger than the memory available to a user. The memory provider then creates a link or a reference to the actual data of the user on the user interface of the user of the computer system CS. Therefore, the user of the computer system CS can retrieve the data at any time. However, the actual physical memory locations of the files are not shown to the user. If the user then deletes the files from the user interface, he/she only deletes the links indicated on the user interface. The memory service provider marks the memory, on which the files are physically stored, as being available once again. Nevertheless, the information of the stored data is still available on a physical level. Therefore, it is possible for unauthorized third parties to read out this memory and thus reach the information of the stored data of the user of the computer system CS.

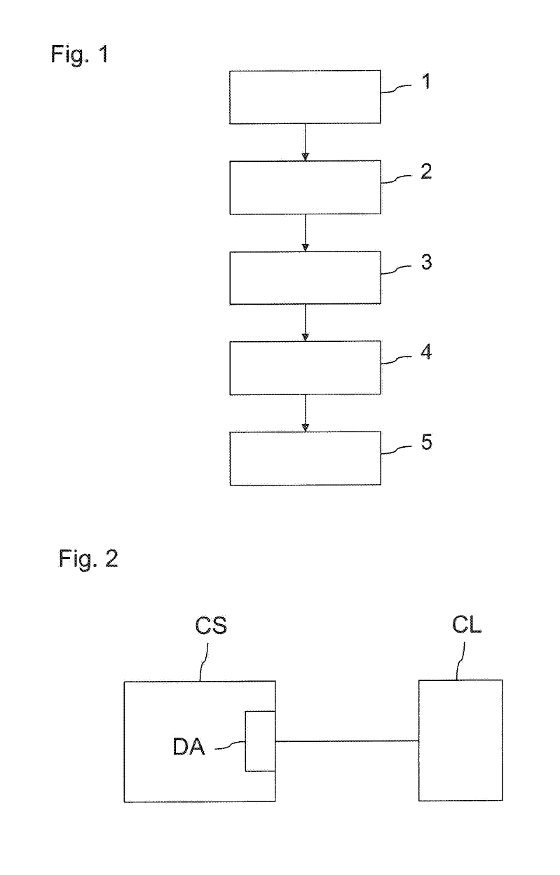

FIG. 1 illustrates a flow diagram used to describe a method by which data can be definitively deleted from a cloud storage memory.

In step 1, the size and name of files stored in the memory CL is determined. For this purpose, the computer system CS uses the data network connection provided via the data network connection DA. By determining the size of the stored files, the occupied memory space of the files on the memory CL is recorded. By determining the name of the files which have been stored by the user on the memory CL, all of the files which the user of the computer system CS has stored on the memory CL are recorded. The determining of the name comprises in this sense the determining of the designation allocated by the user and also the determining of all file endings or names which are allocated when a file is stored. This comprises, e.g., format transmission types such as “.pdf” or “.doc.”

In step 2, files are created which comprise a predetermined content. In the example, the files are container-less files. As a result, it is possible that each individual bit of the file can be determined. In the example, a sequence of logical ones (0xFF) is selected as predetermined content of the file. By virtue of the fact that the files are not container files and therefore can be determined in a bitwise manner, such a file comprising logical ones corresponds to a bit sequence of logical ones which does not contain any content-related information of the original file. These created files are created in a size corresponding to the specific sizes of the files on the memory CL. Accordingly, the names including the format transmission types of the files are also adapted to the stored files.

To delete the stored data on the memory CL, the files stored thereon are overwritten with the created files in step 3. If within a cloud storage memory under normal conditions a file is overwritten, a new file is created which is stored at an undesignated physical memory location and assignment of the memory space of the original file is merely deleted. However, the actual information of the stored original file is retained. Since in the example files are created which are the exact same size and have identical names of the files stored on the memory CL, they are replaced at the physical memory location. Therefore, it is possible to ensure that not only a new allocation of the memory area, which is allocated to the user, takes place on the cloud storage memory but also that overwriting actually takes place at the physical memory location.

If this step has been performed, then only the file size still provides an indication of the originally stored data. To also delete this information, in step 4 a file or several files is/are created which in the example has logical ones (0xFF) written thereto just like the created files. This file is precisely of such a size that it fills the entire remaining memory available to the user of the computer system CS. Alternatively, step 4 can also be performed before step 3. After performing the two steps 3 and 4, the entire memory area available to the user is filled with logical ones and can no longer be allocated to individual data or files. By overwriting the existing files with the files of exactly the same size which comprise the same name and the same format transmission type, it is ensured that the saved data have been deleted from the memory CL.

Step 5 involves waiting until the memory provider of the cloud storage memory makes a backup copy of the data. Therefore, the backup copy is also overwritten with logical ones and the information which can be attributed to the original data of the user of the computer system CS is no longer present.

This type of method can be performed by software on the computer system CS which can be from any manufacturer and can run on any platform. It permits deletion of data in a memory CL, e.g., a cloud storage memory, irrespective of the manufacturer of the computer system CS or of the memory CL and irrespective of the platform which is used to operate the computer system CS or the memory CL.

While in the case of conventional data carriers it is necessary to take into consideration memory effects caused by the storage in a used medium, the technical structure in data centers of the memory service providers of the memory CL mean that memory effects do not have to be taken into consideration. This also equally affects other physical tests which can detect residues on storage media.

1-8. (canceled)

9. A method of deleting information from a memory provided via a data network and having dynamic memory location allocation comprising:
determining the size and name of files stored in the memory;
creating files having a predetermined content and a size and a name corresponding to the determined sizes and names of the files stored in the memory;
overwriting the stored files in the memory with the corresponding created files;
writing at least one file of a predetermined content to the entire remaining available memory; and
waiting for a period of time predetermined by a memory provider to back up the memory, upon completion of the steps of overwriting and writing.

10. The method according to claim 9, wherein the created files and the files for writing to the remaining memory are container-less files whose content can be determined in a bitwise manner.

11. The method according to claim 9, wherein the predetermined contents of the files contain a sequence of logical ones corresponding to the determined length of the file.

12. The method according to claim 9, wherein, in determining, determining the name of the files includes determining a format of the files and, in creating, the name comprises a format-specific file identifier corresponding to the determined name.

13. The method according to claim 9, wherein, in determining, creating and overwriting, the stored files comprise all of the stored files allocated to a user.

14. A computer program product comprising executable program code, wherein the program code is configured to carry out the method according to claim 9 upon execution of the computer program product by a data processing apparatus.

15. A computer system comprising at least one data network connection, wherein the computer system is configured to establish, via the data network connection, a connection to at least one memory provided via a data network and has dynamic memory location allocation, and the computer system is further configured to perform the method according to claim 9.

16. The method according to claim 10, wherein the predetermined contents of the files contain a sequence of logical ones corresponding to the determined length of the file.

17. The method according to claim 10, wherein, in determining, determining the name of the files includes determining a format of the files and, in creating, the name comprises a format-specific file identifier corresponding to the determined name.

18. The method according to claim 11, wherein, in determining, determining the name of the files includes determining a format of the files and, in creating, the name comprises a format-specific file identifier corresponding to the determined name.

19. The method according to claim 10, wherein, in determining, creating and overwriting, the stored files comprise all of the stored files allocated to a user.

20. The method according to claim 11, wherein, in determining, creating and overwriting, the stored files comprise all of the stored files allocated to a user.

21. The method according to claim 12, wherein, in determining, creating and overwriting, the stored files comprise all of the stored files allocated to a user.

22. A computer program product comprising executable program code, wherein the program code is configured to carry out the method according to claim 10 upon execution of the computer program product by a data processing apparatus.

23. A computer program product comprising executable program code, wherein the program code is configured to carry out the method according to claim 11 upon execution of the computer program product by a data processing apparatus.

24. A computer program product comprising executable program code, wherein the program code is configured to carry out the method according to claim 12 upon execution of the computer program product by a data processing apparatus.

25. A computer program product comprising executable program code, wherein the program code is configured to carry out the method according to claim 13 upon execution of the computer program product by a data processing apparatus.
